(19) United States
(12) Patent Application Publication
(10) Pub. No.: US 2015/0079234 A1
(43) Pub. Date: Mar. 19, 2015

(54) SWEETENER COMPOSITIONS

(71) Applicant: Baxco Pharmaceutical, Inc., Walnut, CA (US)

(72) Inventors: Dennis Wong, Hacienda Heights, CA (US); Horst Krupp, Carlsbad, CA (US)

(73) Assignee: Baxco Pharmaceutical, Inc., Walnut, CA (US)

(21) Appl. No.: 14/161,441

(22) Filed: Jan. 22, 2014

Related U.S. Application Data
(63) Continuation-in-part of application No. 14/029,685, filed on Sep. 17, 2013, now abandoned.

(51) Int. Cl. A23L 1/236

(52) U.S. Cl. CPC A23L 1/2364
USPC 426/61; 426/548; 426/72; 426/73; 426/74

(57) ABSTRACT

A sweetener composition comprising xylose, a sugar alcohol and brown seaweed extract in solid form, preferably powdered or crystalline form. The sugar alcohol is preferably an erythritol and the brown seaweed extract is preferably obtained from Laminaria japonica. The sweetener composition can further comprise one or a combination of additional vitamins, minerals, probiotic cultures, and other plant-based extracts.

### CROSS-REFERENCE TO RELATED APPLICATIONS

This application is claims the benefit of, under 35 U.S.C. §120, and is a continuation-in-part of U.S. patent application Ser. No. 14/029,685, filed Sep. 17, 2013, the entire contents of which are incorporated herein by reference as if fully set forth herein.

### FIELD OF THE INVENTION

The present invention relates generally to compositions for use in food and, more particularly, to sweetener compositions for use in enhancing the flavor of foods.

### BACKGROUND

A diet that is high in sugar or sucrose is known to have numerous adverse health effects and to contribute to a wide range of disease states, such as tooth decay, diabetes, obesity, high cholesterol, to name just a few. High sugar consumption also leads to decreased consumption of nutritious foods.

Artificial sweeteners have enjoyed increasing popularity as sugar substitutes. Artificial sweeteners, such as saccharin and aspartame, are widely used to duplicate the taste of sugar, but have fewer calories. Although artificial sweeteners do not contribute to the same sugar-related diseases, the safety of artificial sweeteners have been called into question. For example, Saccharin has been surrounded by controversy as to its safety after studies have linked saccharin to cancer. Similarly, aspartame has been subject to multiple claims against its safety, including supposed links to cancer, as well as complaints of neurological or psychiatric side effects.

The adverse health effects suggested by the use of saccharin and aspartame has intensified the search for new low calorie sweeteners. There is thus a need for low calorie sweeteners which are safe and, at the same time, will eliminate or substantially reduce the amount of sugar used in foods, beverages and confections.

### BRIEF SUMMARY

In one preferred embodiment, a sweetener composition is provided. The sweetener composition comprises xylose, a sugar alcohol and brown seaweed extract.

In accordance with a first aspect of the preferred embodiment, the sugar alcohol is erythritol.

In accordance with a second aspect of the preferred embodiment, the brown seaweed extract is obtained from Laminaria japonica.

In accordance with a third aspect of the preferred embodiment, the sweetener composition consists of xylose, the sugar alcohol, and the brown seaweed extract.

In accordance with a fourth aspect of the preferred embodiment, the sweetener composition comprises 50-90% by weight xylose, 10-50% by weight erythritol, 0.01-1% by weight brown seaweed extract.

In accordance with a fifth aspect of the preferred embodiment, the sweetener composition consists of: 50-90% by weight xylose, 10-50% by weight erythritol, 0.01-1% by weight brown seaweed extract.

In accordance with a sixth aspect of the preferred embodiment, the sweetener composition further comprises one or a combination of vitamins selected from the group consisting of: vitamin A, vitamin B₁, vitamin B₂, vitamin B₃, vitamin B₅, vitamin B₆, vitamin B₇, vitamin B₉, vitamin B₁₂, L-methyl folate, inositol, vitamin C, vitamin D, vitamin E, vitamin K, and CoQ10.

In accordance with a seventh aspect of the preferred embodiment, the sweetener composition further comprises one or more minerals selected from the group consisting of: calcium, chromium, copper, iron, magnesium, manganese, and zinc.

In accordance with an eighth aspect of the preferred embodiment, the sweetener composition further comprises probiotic cultures obtained from one or more strains selected from the group consisting of: Bacillus coagulans, Bifidobacterium animalis, Bifidobacterium longum, Bifidobacterium bifidum, Bifidobacterium breve, Bifidobacterium infantis, Lactobacillus acidophilus, Lactobacillus casei, Lactobacillus paracasei, Lactobacillus johnsonii, Lactobacillus plantarum, Lactobacillus reuteri, Lactobacillus rhamnosus, and Saccharomyces boulardii. The sweetener composition can further comprise fructo-oligosaccharose.

In accordance with a ninth aspect of the preferred embodiment, the sweetener composition comprises one or more omega-3 fatty acid selected from the group consisting of alpha-linolenic acid, eicosapentaenoic acid and docosahexaenoic acid.

In accordance with a tenth aspect of the preferred embodiment, the sweetener composition further comprises a source of dietary fiber.

In accordance with an eleventh aspect of the preferred embodiment, the sweetener composition further comprises longevity fruit extract.

In another preferred embodiment, a sweetener composition is provided. The sweetener composition comprises xylose, a sugar alcohol and one or a combination of a fucoidan, a sulfated polysaccharide, and a fucose.

In accordance with a first aspect of the preferred embodiment, the sugar alcohol is erythritol.

In accordance with a second aspect of the preferred embodiment, the sweetener composition further comprises one or a combination of vitamins selected from the group consisting of: vitamin A, vitamin B₁, vitamin B₂, vitamin B₃, vitamin B₅, vitamin B₆, vitamin B₇, vitamin B₉, vitamin B₁₂, L-methyl folate, inositol, vitamin C, vitamin D, vitamin E, vitamin K, and CoQ10.

In accordance with a third aspect of the preferred embodiment, the sweetener composition further comprises one or more minerals selected from the group consisting of: calcium, chromium, copper, iron, magnesium, manganese, and zinc.

In accordance with a fourth aspect of the preferred embodiment, the sweetener composition comprises probiotic cultures obtained from one or more strains selected from the group consisting of: Bacillus coagulans, Bifidobacterium animalis, Bifidobacterium longum, Bifidobacterium bifidum, Bifidobacterium breve, Bifidobacterium infantis, Lactobacillus acidophilus, Lactobacillus casei, Lactobacillus paracasei, Lactobacillus johnsonii, Lactobacillus plantarum, Lactobacillus reuteri, Lactobacillus rhamnosus, and Saccharomyces boulardii. The sweetener composition can further comprise fructo-oligosaccharose.

In accordance with a fifth aspect of the preferred embodiment, the sweetener composition comprises one or more omega-3 fatty acid selected from the group consisting of alpha-linolenic acid, eicosapentaenoic acid and docosahexaenoic acid.

In accordance with a sixth aspect of the preferred embodiment, the sweetener composition further comprises a source of dietary fiber.

In accordance with a seventh aspect of the preferred embodiment, the sweetener composition further comprises longevity fruit extract obtained from Siraitia grosvenorii.

In a further preferred embodiment, the sweetener composition consists of a xylose, an erythritol, a brown seaweed extract, and one or more additives.

Other objects, features and advantages of the described preferred embodiments will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention can be made without departing from the spirit thereof, and the invention includes all such modifications.

### DESCRIPTION OF THE PREFERRED EMBODIMENTS

Specific, non-limiting embodiments of the present invention will now be described with reference to the preferred embodiments. It should be understood that such embodiments are by way of example only and merely illustrative of but a small number of embodiments within the scope of the present invention. Various changes and modifications obvious to one skilled in the art to which the present invention pertains are deemed to be within the spirit, scope and contemplation of the present invention as further defined in the appended claims.

The sweetener compositions disclosed herein have the advantages of having a mouth-feel or taste that is like sugar (sucrose) but is low in calories and does not produce an insulin response. In a preferred embodiment, the sweetener compositions do not contain any artificial flavors or coloring.

In one embodiment, the sweetener composition comprises a sugar alcohol and plant extracts and, more particularly, brown seaweed extract.

Sugar alcohols are a class of polyols and have the general formula H(HCHO)ₙ₊₁H. Sugar alcohols do not contribute to tooth decay and consumption of sugar alcohols does not affect blood sugar levels in the same way that sucrose does. Common sugar alcohols include methanol, glycol, glycerol, erythritol, threitol, arabitol, xylitol, ribitol, mannitol, sorbitol, galactitol, fucitol, iditol, inositol, volemitol, isomalt, maltitol, lactitol, maltotriitol, maltotetraitol, and polyglycitol. In a preferred embodiment, the sweetener composition comprises one or more sugar alcohol(s). In a particularly preferred embodiment, the sweetener composition comprises at least erythritol.

The brown seaweed extract is preferably obtained from Laminaria japonica. Brown seaweeds are an excellent source of fucoidan, sulfated polysaccharides, and fucose and can be provided in addition to or in place of any one or all of the xylose and sugar alcohol(s).

Fucoidan is a sulfated alpha-L-fucan found in many sea plants and animals. Fucoidan is particularly abundant in the cell walls of brown algae and includes fucoidans derived from the genus Fucus (e.g., Fucus vesiculosis, Fucus evanescens, Fucus distichus, and Fucus serratus) or Laminaria (e.g., Laminaria japonica, Laminaria religiosa, and Laminaria abyssalis).

Fucoidan also includes fucoidans derived from Chorda filum, Cladosiphon okamuranus, Undaria pinnatifada, Leathesia difformis, Ascophyllum nodosum, Ecklonia kurome, Pelvetia fastigiata, Soundersella simplex, Chordaria flagelliformis, or any other species of sea plant or animal containing fucoidan.

In addition, fucoidan includes biologically active fragments, derivatives, or analogues thereof. Fucoidan may include fragments of fucoidan generated by degradation (e.g., hydrolysis) of larger fucoidan molecules. Degradation can be achieved by any of a variety of means known to those skilled in the art including treatment of fucoidan with acid, base, heat, or enzymes to yield degraded fucoidan. Fucoidans may also be chemically altered and may have modifications, including but not limited to, sulfation, polysulfation, acetylation, esterification, and methylation.

The sweetener composition preferably further comprises one or a combination of vitamins and/or minerals.

The vitamins can be any one or a combination of vitamin A, vitamin B₁, vitamin B₂, vitamin B₃, vitamin B₅, vitamin B₆, vitamin B₇, vitamin B₉, vitamin B₁₂, L-methyl folate, inositol, vitamin C, vitamin D, vitamin E, vitamin K, and CoQ₁₀.

The minerals can be any one or a combination of calcium, chromium, copper, iron, magnesium, manganese, and zinc.

In order to aid with digestion and provide other health benefits, the sweetener composition can further comprise probiotic cultures, preferably in powdered form. The probiotic cultures can be any one or a combination of strains selected from the group consisting of: Bacillus coagulans, Bifidobacterium animalis, Bifidobacterium longum, Bifidobacterium bifidum, Bifidobacterium breve, Bifidobacterium infantis, Lactobacillus acidophilus, Lactobacillus casei, Lactobacillus paracasei, Lactobacillus johnsonii, Lactobacillus plantarum, Lactobacillus reuteri, Lactobacillus rhamnosus, and Saccharomyces boulardii. In a preferred embodiment, the sweetener composition can further comprise fructo-oligosaccharose to supplement the probiotic cultures.

The sweetener composition can further comprise one or more omega-3 fatty acid selected from the group consisting of alpha-linolenic acid, eicosapentaenoic acid and docosahexaenoic acid. The one or more omega-3 fatty acid preferably is provided in solid or powdered form.

The sweetener composition can further comprise a source of dietary fiber. The source of dietary fiber can be derived from legumes, whole grains, brown rice, nuts, berries, vegetable, and the like. The source of dietary fiber can also be indigestible, such as psyllium husk or seeds.

Longevity fruit extract can optionally be provided in the sweetener composition in addition to or in place of any of the foregoing constituents. In a preferred embodiment, the longevity fruit is derived from Siraitia grosvenorii, an herbaceous perennial vine of the cucurbitaceae (gourd) family native to southern China and northern Thailand. Longevity fruit extract is nearly 300 times sweeter than sugar.

The sweetener compositions can further comprise at least one additive selected from the group consisting of plasticizers, bulking agents, fillers, mineral adjuvants, coloring agents and mixtures thereof.

In a particularly preferred embodiment, all of the constituents comprising the sweetener composition are provided in solid, crystalline and/or powdered form.

The relative amounts for the constituents of the sweetener composition can be optimized to provide the mouth feel and taste of sugar. Table 1 provides relative ranges of the constituents described above in accordance with one preferred embodiment:

TABLE 1

| Ingredient | Amount (% by weight) |
|---|---|
| xylose | 50-90 |
| Erythritol | 10-50 |
| Fucoidan | 0-10 |
| Brown seaweed extract | 0-10 |
| Longevity Fruit Extract | 0-10 |
| Vitamins | 0-10 |
| Minerals | 0-10 |
| Probiotics | 0-10 |
| Omega-3 fatty acids | 0-10 |
| Dietary fiber | 0-10 |
| Additives | 0-5 |

### EXAMPLE 1

A sweetener composition comprising 70% xylose, 29.86% erythritol and 0.14% of brown seaweed extract obtained from Laminaria japonica in solid form.

Preparation of the Brown Seaweed Extract.

Brown seaweed, preferably from Laminaria japonica, is cleaned to remove impurities such as mud, sand and salt. The brown seaweed is then smashed into powdered form and the powder is sieved. The brown seaweed is extracted with water at a temperature of 60-80° C. for 4 hours or more and the extract is filtered and centrifuged to remove impurities. After centrifugation, the extract is concentrated to 1/6 to 1/10 of the original volume. The concentrate is filtered using an ultrafiltration membrane module to remove most of the small molecules and heavy metal impurities. Ninety-five percent (95%) food grade ethanol is to the filtered concentrate to precipitate the salt and the concentrate is again centrifuged to remove the salt and other impurities. This step is repeated at least one more time. The precipitate is washed with 95% anhydrous ethanol to remove the residual moisture and is dried at a temperature of 50-60° C. The precipitate is smashed with a crusher and sieved to produce a fine powder.

Characterization of the Brown Seaweed Extract.

A glycosyl composition analysis performed by gas chromatography and mass spectrometry (GC/MS) of the per-O-trimethylsilyl (TMS) derivatives of the monosaccharide methyl glycosides produced from the brown seaweed extract by acidic methanolysis. Table 2 provides the results of the glycosyl composition analysis.

TABLE 2

| Glycosyl residue | mol % |
|---|---|
| Rhamnose | 2.2 |
| Fucose | 25.6 |
| Xylose | 1.1 |
| Glucuronic acid | 0.4 |
| Mannose | 1.6 |
| Galactose | 16.1 |
| Glucose | 53.0 |
| TOTAL: | 100 |

### EXAMPLE 2

A sweetener composition comprising 70% xylose, 29.86% erythritol and 0.14% any one or a combination of fucoidan, sulfated polysaccharide or sulfated alpha-L-fulcan, or fucose.

The invention described and claimed herein is not to be limited in scope by the specific preferred embodiments disclosed herein, as these embodiments are intended as illustrations of several aspects of the invention. Indeed, various modifications of the invention in addition to those shown and described herein will become apparent to those skilled in the art from the foregoing description. Such modifications are also intended to fall within the scope of the appended claims.

1. A sweetener composition consisting of: a xylose, a sugar alcohol and a brown seaweed extract, wherein the relative amounts of the xylose, sugar alcohol and brown seaweed extract are present in the sweetener composition to provide a mouth feel and taste like sucrose.

2. The sweetener composition of claim 1, wherein the sugar alcohol is erythritol.

3. The sweetener composition of claim 1, wherein the brown seaweed extract is obtained from Laminaria japonica.

4. (canceled)

5. The sweetener composition of claim 1 consisting of: 50-90% by weight xylose, 10-50% by weight erythritol, and 0.01 1% 0 10% by weight brown seaweed extract.

6. A sweetener composition consisting of: a xylose, a sugar alcohol, a brown seaweed extract obtained from Laminaria japonica, and one or a combination of vitamins, minerals, probiotic cultures, fructo-oligosaccharose, omega-3 fatty acids, and longevity fruit extract, wherein the relative amounts of the xylose, sugar alcohol and brown seaweed extract are present in the sweetener composition to provide a mouth feel and taste like sucrose.

7. The sweetener composition of claim 6, wherein the one or more vitamins are selected from the group consisting of: vitamin A, vitamin B1, vitamin B2, vitamin B3, vitamin B5, vitamin B6, vitamin B7, vitamin B9, vitamin B12, L-methyl folate, inositol, vitamin C, vitamin D, vitamin E, vitamin K, and CoQ10.

8. The sweetener composition of claim 6, wherein the one or more minerals are selected from the group consisting of: calcium, chromium, copper, iron, magnesium, manganese, and zinc.

9. The sweetener composition of claim 6, wherein the probiotic cultures are obtained from one or more strains selected from the group consisting of: Bacillus coagulans, Bifidobacterium animalis, Bifidobacterium longum, Bifidobacterium bifidum, Bifidobacterium breve, Bifidobacterium infantis, Lactobacillus acidophilus, Lactobacillus casei, Lactobacillus paracasei, Lactobacillus johnsonii, Lactobacillus plantarum, Lactobacillus reuteri, Lactobacillus rhamnosus, and Saccharomyces boulardii.

10. The sweetener composition of claim 6, wherein the composition consists of: the xylose, the erythritol, the brown seaweed extract and the fructo-oligosaccharose.

11. The sweetener composition of claim 6, wherein the one or more omega-3 fatty acids are selected from the group consisting of alpha-linolenic acid, eicosapentaenoic acid and docosahexaenoic acid.

12-21. (canceled)

22. The sweetener composition of claim 6 wherein the longevity fruit extract is obtained from Siraitia grosvenorii.

23. (canceled)

24. The sweetener composition of claim 1 consisting of: about 70% by weight xylose, 29.86% by weight erythritol and 0.14% by weight brown seaweed extract from Laminaria japonica.
